(19) United States
(12) Patent Application Publication
(10) Pub. No.: US 2012/0003911 A1
(43) Pub. Date: Jan. 5, 2012

(54) Tractor Cab Heating and Ventilating Systems

(75) Inventors: Hermann Geiss, Marktoberdorf (DE); Andreas Stieglitz, Marktoberdorf (DE)

(73) Assignee: AGCO GMBH, Marktoberdorf (DE)

(21) Appl. No.: 13/139,111

(22) PCT Filed: Dec. 11, 2009
(86) PCT No.: PCT/EP09/66926

§ 371 Date: Sep. 13, 2011

(30) Foreign Application Priority Data
Dec. 11, 2008 (GB) 0822586.4

(51) Int. Cl. B60H 1/26

(52) U.S. Cl. 454/143

(57) ABSTRACT

A tractor cab HVAC system having an HVAC unit (11) which receives and processes fresh air drawn in via an air intake (43) and recirculated air from at least one recirculation duct (47). The system has at least one air distribution duct (27,28) through which processed air from the HVAC unit is introduced into the cab. A first blower (23) is provided which primarily distributes processed air from the HVAC unit (11) to the distribution duct (27,28), and a second blower (22) which selectively draws air into the HVAC unit (11) through the air intake (43) and/or re-circulation duct (47). The ratio of fresh air to recirculated air drawn into the HVAC unit (11) by the second blower (22) is variable by one or more flaps (60,62) which control the flow of air into the HVAC unit (11) through the air intake (43) and circulation duct (47).

This invention relates to tractor cabs and in particular to such cabs having heating, ventilating and air conditioning (HVAC) systems.

The term “HVAC system” or “HVAC unit” as used throughout this patent application is to be interpreted as covering a system or unit which at its simplest simply draws air in via a filter and distributes this filtered air to the inside of the cab or a system or unit which additional heats and/or conditions the air which is drawn in via the filter.

Such HVAC systems include an HVAC unit which draws air in from the outside of the cab via an air intake and ducting and delivers processed air to the interior of the cab by further ducting. The HVAC unit may be installed in a number of locations such as in the roof of the cab, below the driver's seat and even below the cab floor.

The performance of an HVAC system focusing on blower installation can be described by the two operating conditions:
a first condition (fresh air mode), in which the main task of the HVAC system is to add fresh air to the cab to ensure air quality (to avoid suffocation and to control the CO ratio) at an certain temperature level and also to ensure a minimum overpressure inside of the cab to avoid dust entering the cab through leaks e.g. in door sealings or bowden cable or wiring harness feedthroughs.
a second condition (recirculation mode), in which the main task of the HVAC system is to cool down or heat up the cab as fast as possible to achieve the desired inside cab temperature. Therefore, air is recirculated inside the cab and heated up or cooled down instead of sucking air from outside of the cab with a higher temperature difference.

Very long ducts (to draw-in and distribute air) cause massive pressure losses which can often not be overcome if only one (main) blower is installed. It is therefore quite common for HVAC systems with higher performance and comfort requirements to install two blowers for air intake and distribution inside the cab:
a first pressurization blower is provided to suck fresh air from outside of the cab into the HVAC unit.
a second main blower is provided to suck recirculation air from inside of the cab and air which was already sucked into the HVAC unit by the smaller, pressurization blower and then mix and distribute both air streams into the cab interior.

Due to these different functions, the required performance for a main blower is much bigger than the pressurization blower. In practice, the main blower has a delivery rate of 1200 m3/h (net delivery rate), while the pressurization blower has a delivery rate of 800 m3/h (net delivery rate). This big difference results from the fact, that the main blower has to overcome pressure losses in the recirculation duct(s), recirculation filter(s) and the distribution ducts while the pressurization blower only has to overcome the pressure losses in the fresh air duct(s) and fresh air filter(s). As the size and costs of these blowers are similar to their delivery rate, these installations are very voluminous and expensive. It is also obvious that the first pressurization blower is only supporting fresh air intake while the recirculation air intake has to be provided by the second main blower in addition to the distribution into the cab.

It is an object of the present invention to provide an HVAC system design with a more compact design and a blower installation with an additional second blower supporting fresh and recirculation air intake.

Thus according to the present invention there is provided a tractor cab HVAC system having an HVAC unit which receives and processes fresh air drawn in via an air intake and recirculated air from at least one recirculation duct; at least one air distribution duct through which processed air from the HVAC unit is introduced into the cab; a first blower which primarily distributes processed air from the HVAC unit to the distribution duct, and a second blower which selectively draws air into the HVAC unit through the air intake and/or recirculation duct.

As will be appreciated, a HVAC system which such design reduces costs and installation space as, instead of one big blower and a small blower, two blowers with nearly or exactly the same size can be installed with a net delivery rate much lower than would be necessary if a single blower was used. Typically a net power for both blowers of about 800 m3/h should be sufficient. As both blowers will have similar delivery rates, they do not negatively influence each other (blocking each other) while the pressure performance of this blower combination is, under certain conditions, nearly doubled thus increasing their capability to overcome pressure losses in the fresh air and recirculation intake and even in the distribution system after the HVAC unit.

By using two similar blowers, delivery costs and efforts can also be reduced, logistics and spare parts supply is also easier to handle.

As will be appreciated, this design is very advantageous as both operation modes are improved by the additional blower.

This design is very advantageous for small units needed in vineyard tractors or roof mounted HVAC systems with high visibility requirements where space is at a premium. By using two smaller and cheaper blowers, cost and space savings can be significant.

Other features of the invention are set out in the sub-claims of the application.

The present invention will now be described, by way of example only, with reference to the accompanying drawings in which: —

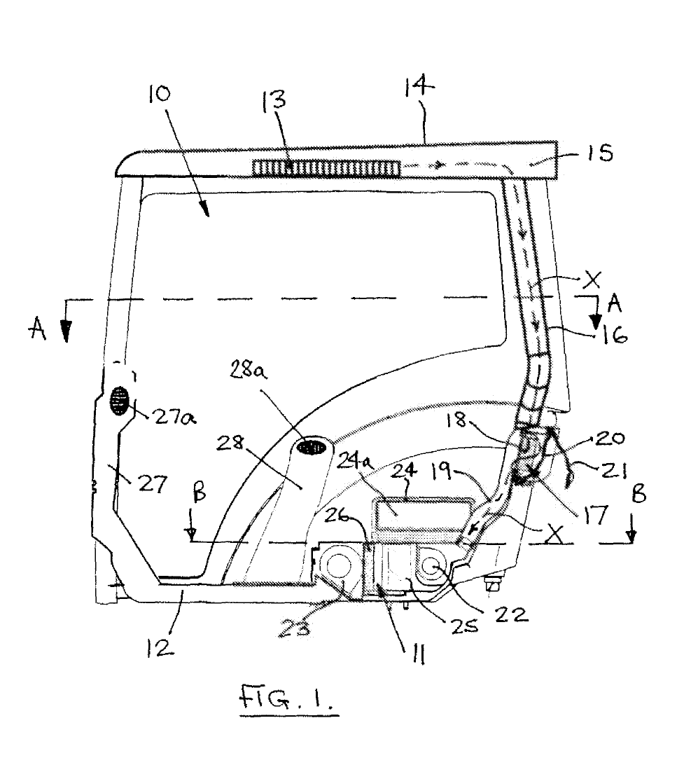

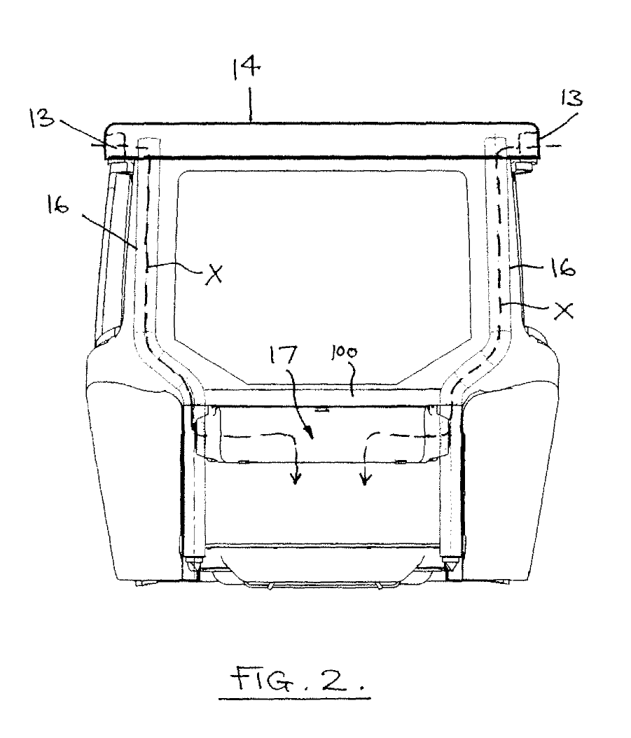

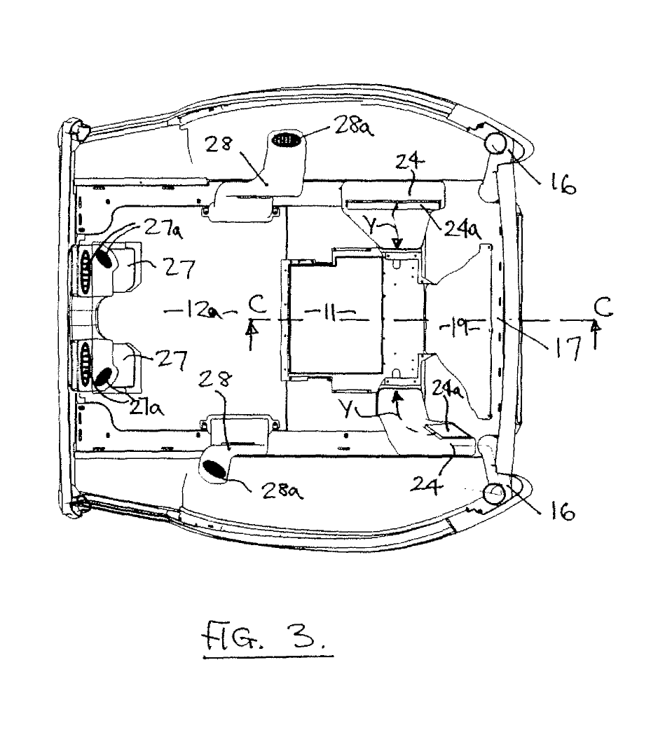

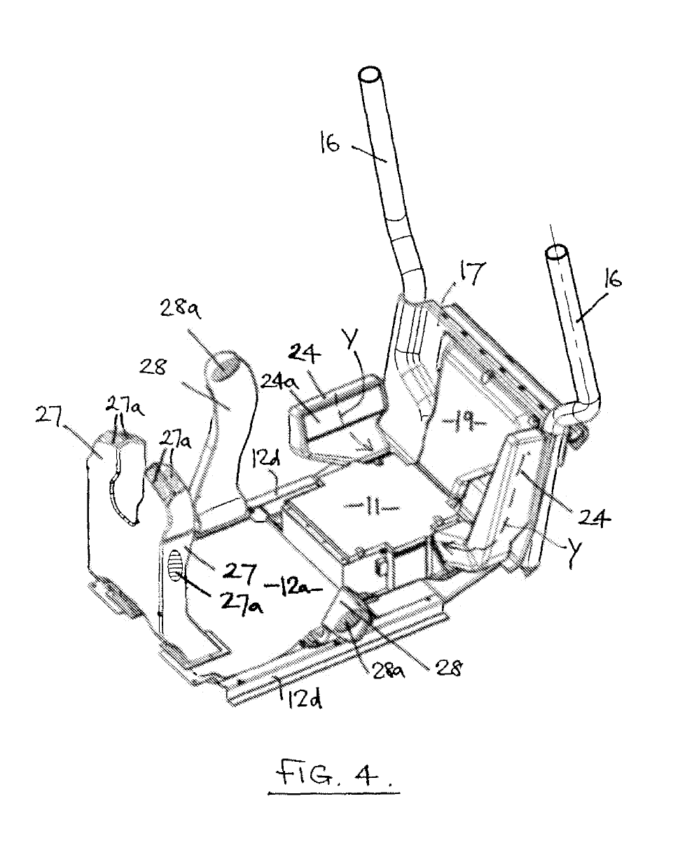

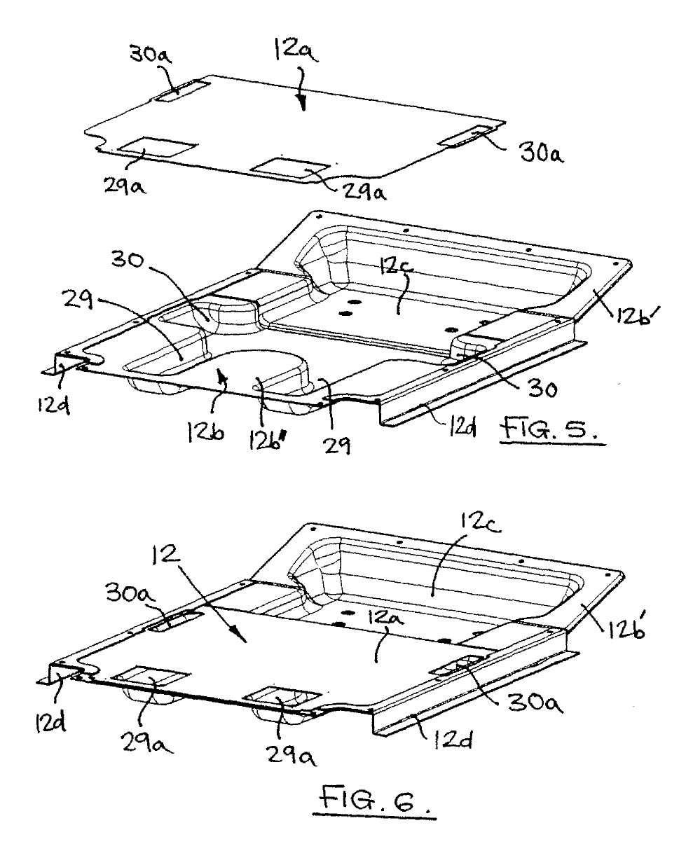

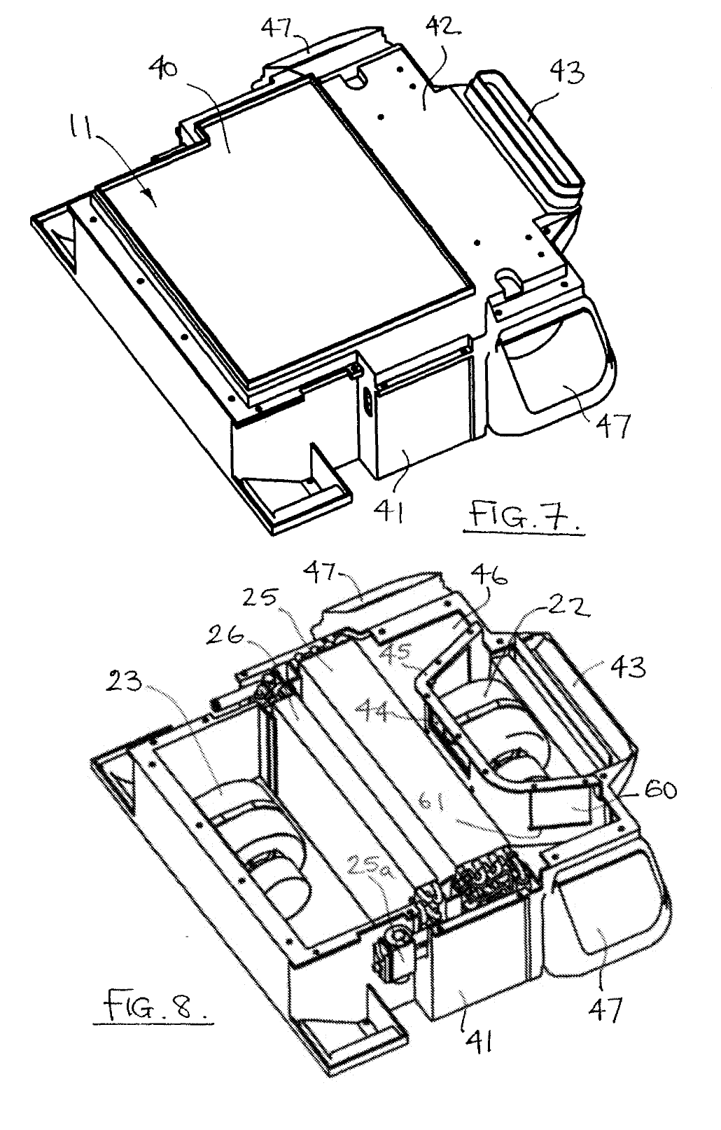

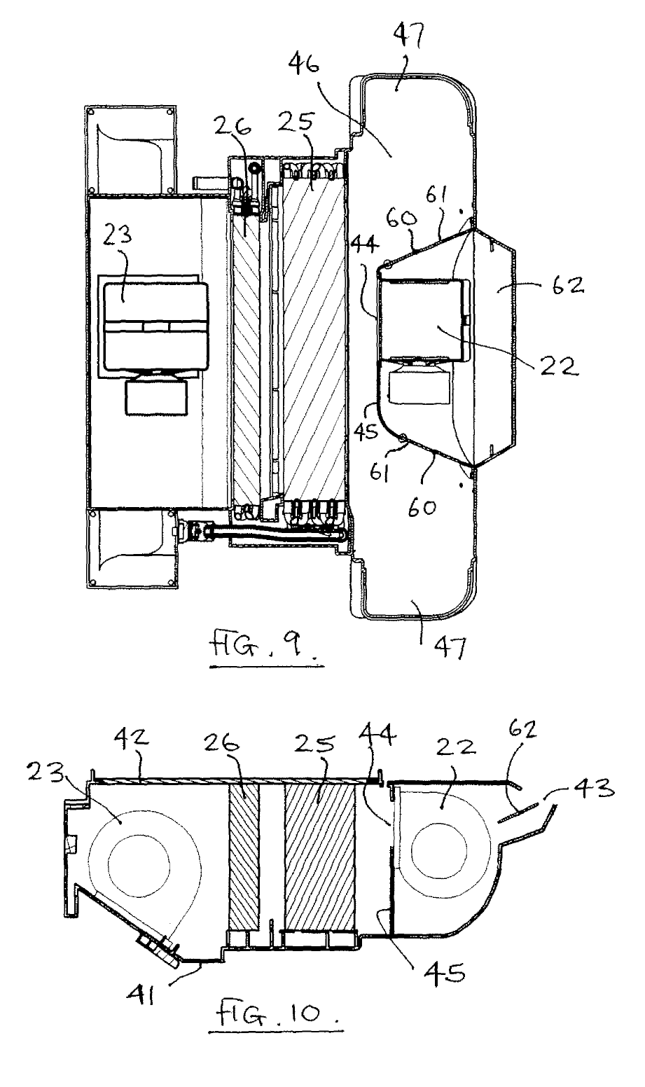

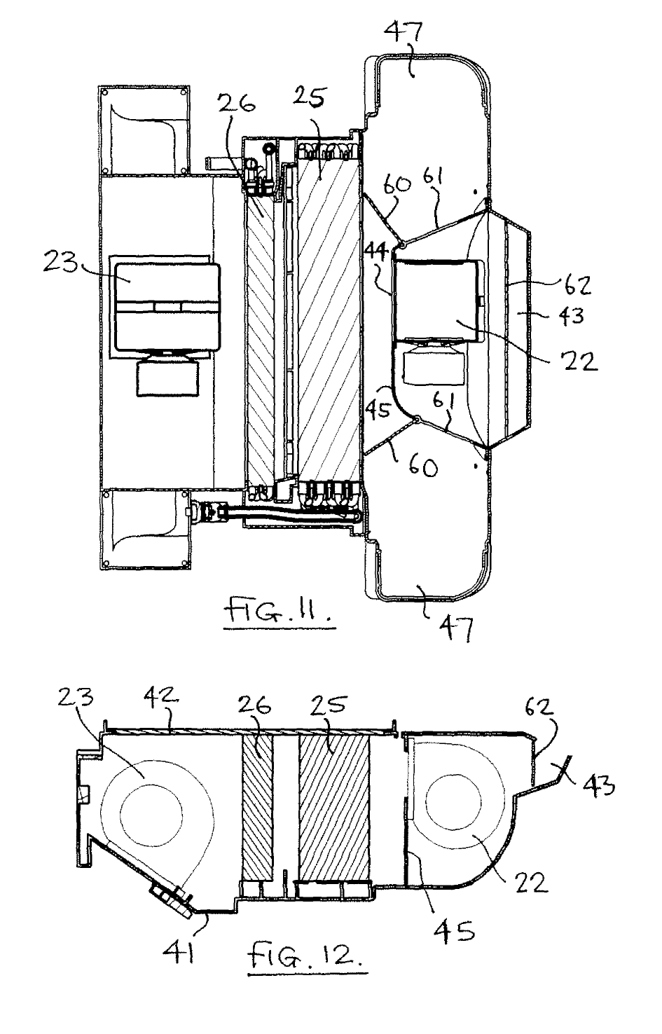

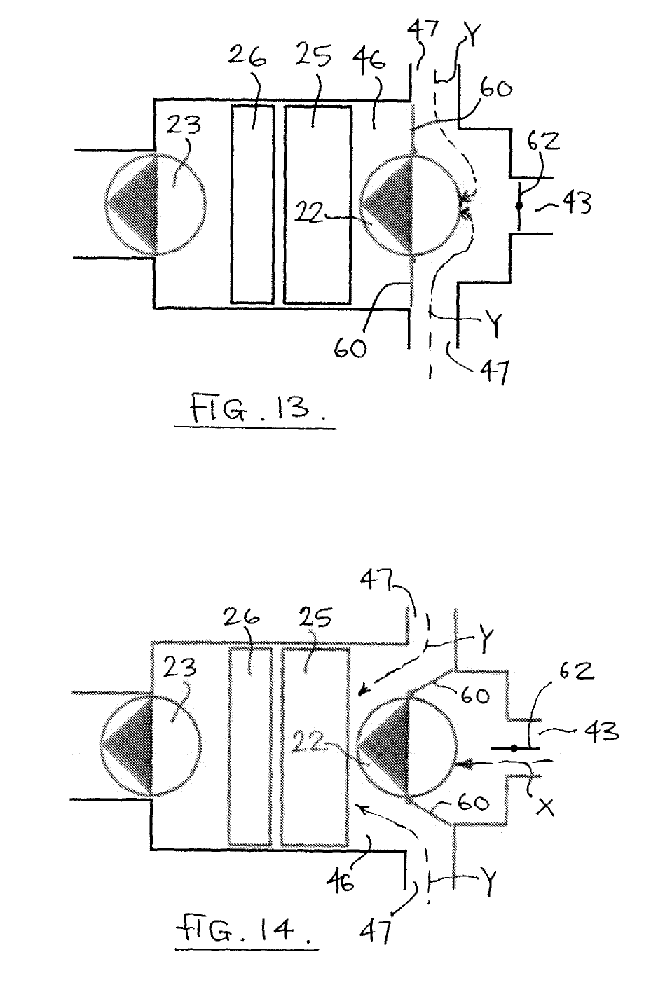

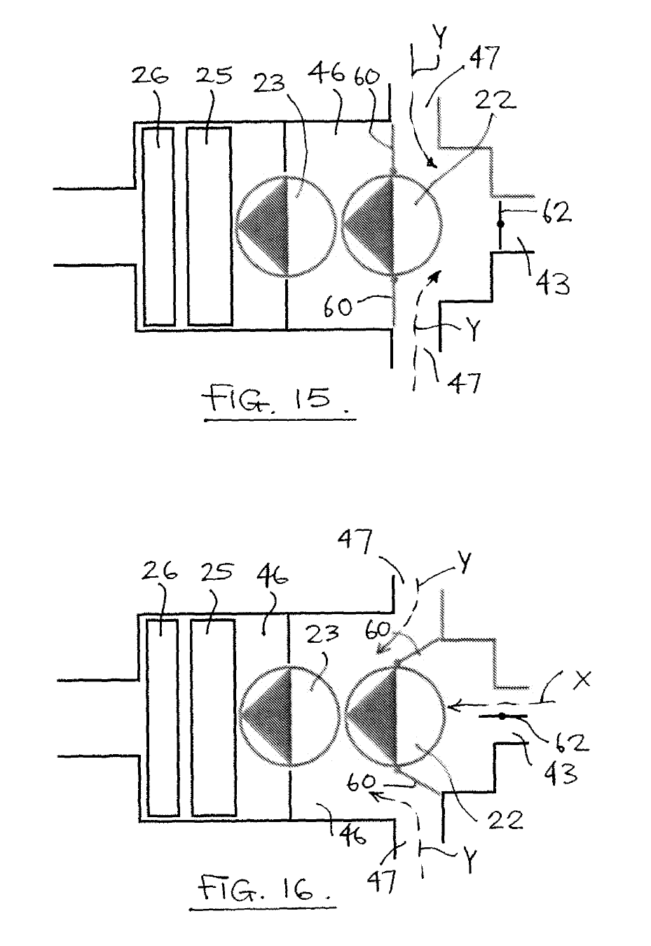

FIG. 1 shows a side view, partly in section, of a tractor cab having an HVAC system in accordance with the present invention;

FIG. 2 show a rear view of the cab of FIG. 1;

FIG. 3 shows a section on the line A-A of FIG. 1;

FIG. 4 shows a perspective view of part of the lower part of the cab of FIG. 1;

FIG. 5 shows an exploded perspective view of the two layer cab floor;

FIG. 6 shows the floor of FIG. 5 assembled;

FIG. 7 shows a perspective view of an HVAC unit used in the HVAC system of the present invention;

FIG. 8 shows the HVAC unit of FIG. 7 with its cover removed for clarity;

FIG. 9 shows a section of the present invention on the line B-B of FIG. 1 in the first flap position (fresh air mode);

FIG. 10 shows a section of the present invention on the line C-C of FIG. 3 in the first flap position (fresh air mode);

FIG. 11 shows a section of the present invention on the line B-B of FIG. 1 in a second flap position (recirculation mode);

FIG. 12 shows a section on the line C-C of FIG. 3 in the second flap position (recirculation mode);

FIG. 13 shows a diagrammatic scheme of the HVAC unit as shown in FIG. 14;

FIG. 14 shows a diagrammatic scheme of the HVAC unit as shown in FIG. 9;

FIG. 15 shows a diagrammatic scheme of a further embodiment in a first flap position (recirculation mode);

FIG. 16 shows a diagrammatic scheme of a further embodiment in a second flap position (fresh air mode);

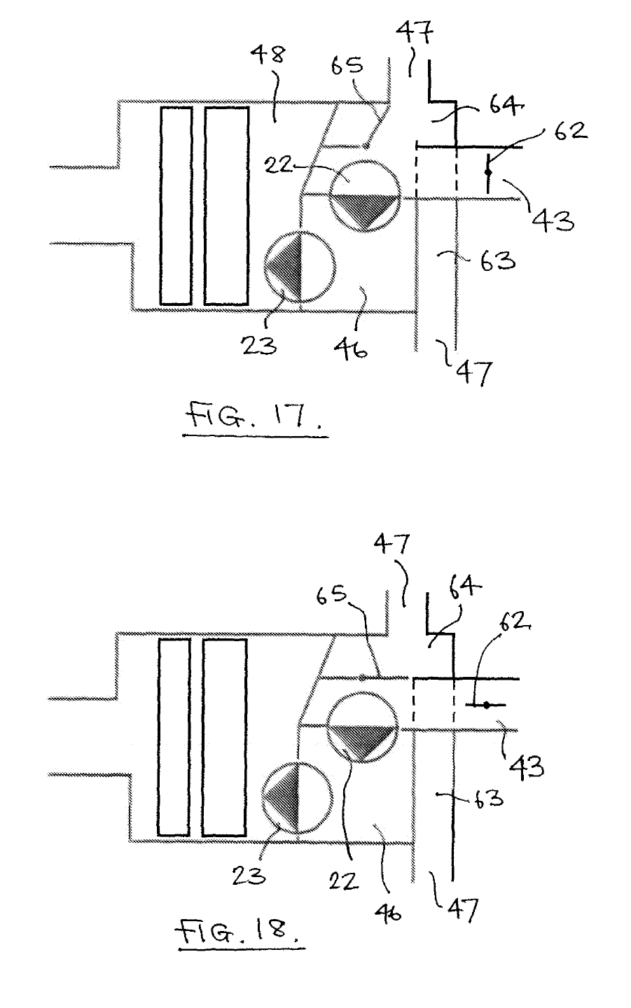

FIG. 17 shows a diagrammatic scheme of a still further embodiment in a first flap position (recirculation mode);

FIG. 18 shows a diagrammatic scheme of a still further embodiment in a second flap position (fresh air mode);

Referring to the drawings, a tractor cab 10 has a HVAC unit 11 mounted on the floor 12 of the cab. Air intakes 13 are provided in the sides of the roof 14 of the cab through which air is drawn into the HVAC unit 11 via ducts 15 in the roof and both rear pillars 16 of the cab and through a fresh air filter unit 17 which contains a filter element 18 into a duct 19 connected with the intake of the HVAC unit 11. A cross member 100 extends between the pillars 16. By drawing air into the system via intakes 13 in the roof the level of dust and dirt in the intake air is minimised. The air flow from intakes 13 to the HVAC unit 11 is shown by the dotted line paths X in FIGS. 1 and 2.

The fresh air enters filter unit 17 generally horizontally from both sides. The air filter unit has a housing 20 provided with an opening access door 21 enabling the operator to access the filter element 18 for maintenance or renewal.

The recirculation air is enters the HVAC unit through ducts 24 which are each provided with a recirculation air filter element 24a placed to the side of the cab seat near the fenders. These filters must also be readily removeable for maintenance. The air flow from recirculation air filter element 24a to the HVAC unit 11 is shown by the dotted line paths Y in FIGS. 3 and 4.

In accordance with the Applicant's co-pending UK Patent Application No. [Applicant's Reference 7887], the HVAC unit 11 is connected with the distributors 27 and 28 by cavities in the form of passages 29 and 30 formed in the hollow floor 12 of the cab (see FIG. 5). It is a main task of these passages in the floor to transport the air from the HVAC unit with a minimum of pressure drop and noise emission. The floor 12 comprises an upper layer 12a and a lower layer 12b which are welded and sealed together to provide the necessary structural integrity of the floor and to seal the sides of the passages 29 and 30 (see FIG. 6). The HVAC unit 11 is mounted in a recess 12 c provided in the rear portion 12b′ of the lower layer 12b of the floor. As most clearly visible in FIG. 5, the rear portion 12b′ of the lower layer 12b of the floor is a separate component which is welded or otherwise secured to the front portion 12b″ of the lower layer. This facilitates manufacture of the lower layer 12b. Flanges 12d are welded or otherwise secured to the sides of lower layer 12b for securing the floor of the other structural portions of the cab. The upper layer 12a has outlets 29a and 30a which connect passages 29 and 30 with distributors 27 and 28 respectively.

The floor layer 12a and 12b may be made from steel sheets which or can be made from reinforced plastics material which is glued or otherwise secured together.

The HVAC unit 11 has a housing 40 with is preferably injection moulded and has a lower part 41, including recirculation intakes 47 on both sides and a fresh air intake 43 on the rear, and a cover 42. (see FIG. 7).

According the present invention shown in FIGS. 8 to 12, the HVAC unit 11 includes a first blower 22 to suck air into the unit via fresh air duct 19 via path X and/or via recirculation ducts 24 via path Y to overcome the pressure drop caused by the long air intake path X and recirculation path Y, which is somewhat restrictive due to being narrow and including various bends. To adjust whether fresh air or recirculation air or a certain ratio between both air streams is sucked by first blower 22, two pivotable recirculation air flaps 60 close or open apertures 61 in a parition wall 45 and a pivotable fresh air flap 62 closes or opens the fresh air intake 43 in the lower part 41 of the HVAC housing.

A second blower 23 is also provided to push air from the HVAC unit 11 into the cab and to draw air through an evaporator 25 and a heater core 26.

The heater core 26 is provided with an electronically controlled valve (not shown) for regulating the mass flow and therefore the heating performance of the heater core 26. The evaporator is also equipped with an evaporator valve 25a for vapourizing the refrigerant.

Additionally the overall control unit for the HVAC system can be housed within the housing 40 of the HVAC unit 11. The HVAC unit 11 also has an external central electric connector for all the electrical connections of the unit thus providing easy plug and play installation of the HVAC unit.

All flaps 60,62 are driven by electric motors (not shown) which can be provided only for open-close movement or, if the ratio between fresh air and recirculation air must be controlled continuously, can provide by stepwise movement to achieve a variety of positions between open and closed positions. These flaps can also be conjointly driven by one motor if the flaps are linked by connecting means and e.g. the recirculation flaps 60 are simultaneously opened when the fresh air flap 62 is closed and vice versa. Flaps 60,62 are controlled, together with both blowers 22,23, by the control unit for the HVAC system.

If both recirculation air flaps 60 are closed and the fresh air flap 62 is opened, as shown in FIGS. 9 and 10, fresh air from filter unit 17 is drawn into the HVAC unit 11 via fresh air intake 43 by the first blower 22 and pushed, via an aperture 44 in a partition wall 45, into a reservoir chamber 46 which is placed ahead of the evaporator 25.

If both recirculation air flaps 60 are opened and the fresh air flap 62 is closed, as shown in FIGS. 11 and 12, recirculation air from recirculation duct 24 is drawn into the HVAC unit 11 via recirculation intake 47 by the first blower 22 and also pushed, via the aperture 44 in the partition wall 45, into the reservoir chamber 46.

The fresh air and recirculation air flows, are mixed in the reservoir chamber 46 and then sucked through evaporator 25 and heater core 26. Depending on the mode or set-point of the cab temperature, heater core 26 or evaporator 25 is heating up or cooling down the air stream. Finally, the second blower 23 pushes the HVAC output air to the distributors 27 and 28.

The ratio between fresh air and recirculated air in a design according the present invention is mainly regulated by the positions of the flaps 60,62 as first blower 22 is sucking fresh air or recirculation air into the HVAC unit 11 depending on the position of these flaps.

The above described embodiment and it's adjustment of fresh air and recirculation air ratio is shown diagrammatically in FIGS. 13 and 14, whereby in FIG. 13 is showing the recirculation air flaps 60 in opened and fresh air flap 62 in closed position. In this position, no fresh air can enter the HVAC system 11 via intake 43 along path Y, so the air sucked by first blower 22 is completely delivered from recirculation intake 47.

FIG. 14 shows the recirculation air flaps 60 closed and fresh air flap 62 open. Thus the first blower 22 is sucking only fresh air via fresh air intake 43 along path X. But as the reservoir chamber 46 is still connected to the recirculation intake, the second blower 23 can also suck in recirculation air. But due to similar delivery rates of both blowers, it is likely that the amount of recirculation air is very low (in a new condition without significant filter load).

FIGS. 15 and 16 show an alternative embodiment with the second blower 23 being installed prior to the evaporator 25 and heater core 26. In this arrangement chamber 46 connects the blowers 22,23 and a further chamber 48 is provided between second blower 23 and evaporator 25. FIG. 15 shows the recirculation mode and in FIG. 16 the fresh air intake 43 is open as in FIG. 14.

FIGS. 17 and 18 show an embodiment which is different concerning the adjustment of the fresh air and recirculation air ratio.

In this construction the recirculation air intake 47 can be completely disconnected from the chambers 46 when the first blower 22 is designated to suck fresh air only without any recirculation air.

Both recirculation air intakes 47 are connected with an internal duct 63, which crosses separately fresh air intake 43. As both recirculation air streams are merged in recirculation chamber 64, only one recirculation flap 65 is required. Both flaps 65 and 62 could again be driven by one electric motor and connected to ensure that when one flap is opened the other flap is closed.

If recirculation air flap 65 is opened and the fresh air flap 62 is closed, as shown in FIG. 17, recirculation air from recirculation duct 24 is drawn into the HVAC unit 11 via recirculation intake 47 by the first blower 22 and also pushed into the chamber 46, which is placed ahead of the second blower 23, and sucked by second blower 23 into chamber 48.

If recirculation air flap 65 is closed and the fresh air flap 62 is opened, as shown in FIG. 18, fresh air from filter unit 17 is drawn into the HVAC unit 11 via fresh air intake 43 by the first blower 22 and pushed into the chamber 46 and sucked by second blower 23 into chamber 48. The recirculation intake 47 can thus only be connected to chamber 46 or chamber 48 when the recirculation flap 65 is opened as shown in FIG. 17, so the second blower can not suck any recirculation air in when operating in the FIG. 18 condition.

It is obvious, that both blowers could be of a different size and delivery rate. In such an arrangement both blowers must then be capable of being towed (following the delivery rate) of the other blower.

If the recirculation flap(s) and fresh air intake flap are driven by separate motors a greater variation in the percentage of fresh and recirculated air if possible.

It is also obvious that the blowers and flaps can be installed in several different positions to each other or even in different housings using the above described invention.

1. A tractor cab HVAC system having an HVAC unit which receives and processes fresh air drawn in via an air intake and recirculated air from at least one recirculation duct; at least one air distribution duct through which processed air from the HVAC unit is introduced into the cab; a first blower which primarily distributes processed air from the HVAC unit to the distribution duct, and a second blower which selectively draws air into the HVAC unit through the air intake and/or recirculation duct.

2. A system according to claim 1 in which the ratio of fresh air to recirculated air drawn into the HVAC unit by the second blower is variable by one or more flaps which control the flow of air into the HVAC unit through the air intake and circulation duct.

3. A system according to claim 2 in which the or each recirculation duct is provided with a respective recirculation flap which when closed stops recirculation air being drawn into the HVAC unit by the second blower, the air intake also being provided with a fresh air flap which when closed stops fresh air being drawn into the HVAC unit by the second blower.

4. A system according to claim 2 in which there are a plurality of recirculation ducts which are controlled by a single recirculation flap which when closed stops recirculation air being drawn into the HVAC unit by the second blower, the air intake also being provided with a fresh air flap which when closed stops fresh air being drawn into the HVAC unit by the second blower.

5. A system according to claim 3 in which each flap is controlled by a separate electric motor.

6. A system according to claim 3 in which the flaps are controlled by a single motor with their relative movement coordinated.

7. A system according to claim 1 in which the HVAC unit includes air processing units and the first blower is located downstream of the processing units with the second blower upstream of the processing units.

8. A system according to claim 1 in which the HVAC unit includes air processing units both blowers are located upstream of the processing units with the second blower being upstream of the blower.
